(19) United States
(12) Patent Application Publication
(10) Pub. No.: US 2004/0225748 A1
(43) Pub. Date: Nov. 11, 2004

(54) Systems and methods for deleting transactions from multiple fast data streams

(76) Inventor: Huai-Ter Victor Chong, Dallas, TX (US)

Correspondence Address: HEWLETT-PACKARD COMPANY, Intellectual Property Administration, P.O. Box 272400, Fort Collins, CO, 80527-2400, US

(21) Appl. No.: 10/434,637

(22) Filed: May 9, 2003

(51) Int. Cl. G06F 15/16

(52) U.S. Cl. 709/236

(57) ABSTRACT

Systems and method deleting transactions from multiple fast data streams. Header packets of the fast data streams are processed into a single fast data stream. A header packets of unwanted one of the transactions is deleted. Data packets of only the transactions containing undeleted header packets is processed into the single fast data stream.

### RELATED APPLICATIONS

This application is related to the following commonly owned and co-filed U.S. patent applications, filed May 9, 2003 and incorporated herein by reference: SYSTEMS AND METHODS FOR GENERATING TRANSACTION IDENTIFIERS (Attorney Docket 200300029); SYSTEMS AND METHODS TO INSERT BROADCAST TRANSACTIONS INTO A FAST DATA STREAM OF TRANSACTIONS (Attorney Docket 200300027); SYSTEMS AND METHODS FOR COMBINING A SLOW DATA STREAM AND A FAST DATA STREAM INTO A SINGLE FAST DATA STREAM (Attorney Docket 200300026); and SYSTEMS AND METHODS FOR INCREASING TRANSACTION ENTRIES IN A HARDWARE QUEUE (Attorney Docket 200300011).

### BACKGROUND

In a high speed server consisting of multiple processors, a core electronics complex, also known as a “chipset,” provides communications between processors and various support devices (e.g., random access memory, and disk drives. etc.). The support devices communicate with the chipset using a plurality of fast data streams over one or more busses. Information in the data streams is contained in transactions constructed from one header packet and zero, one or more data packets.

The chipset operates to combine the fast data streams into a single fast data stream. As the chipset processes transactions of the fast data streams, it may determine that a transaction is erroneous and/or redundant, and delete the transaction from the fast data stream. The deletion of transaction must be done without corrupting or significantly delaying other transactions.

The deletion of a transaction is difficult, in part because the chipset receives transactions from two or more fast data streams simultaneously and interleaves header and data packets. Since the relative ordering of data packets within a transaction must be maintained, deleting the transaction cannot affect ordering of the interleaved transactions.

Prior art solutions typically delete header and data packets for erroneous and redundant transactions without regard to how such action affects in-progress transactions. These solutions can compromise steady-state processing of input data streams and the relative ordering of neighboring transactions. Such solutions also utilize complicated logic and are expensive to implement.

### SUMMARY OF THE INVENTION

In certain embodiments, a method deletes transactions from multiple fast data streams, including: processing header packets of transactions of the fast data streams into a single fast data stream; deleting a header packet of each unwanted one of the transactions; and processing data packets of only the transactions containing undeleted header packets into the single fast data stream.

In certain embodiments, a system deletes transactions from multiple fast data streams. A header processor processes header packets of transactions of the multiple fast data streams into a single fast data stream. The header processor is operable to determine and delete a header packet of each unwanted transaction. A data processor is responsive to the header processor to process data packets of only the transactions containing undeleted header packets into the single fast data stream.

In certain embodiments, a system deletes transactions from multiple fast data streams, and includes: means for processing header packets of transactions of the fast data streams into a single fast data stream; means for deleting a header packet of each unwanted one of the transactions; and means for processing data packets of only the transactions containing undeleted header packets into the single fast data stream.

### BRIEF DESCRIPTION OF THE FIGURES

FIG. 1 is a block diagram showing one system for deleting transactions from multiple fast data streams.

FIG. 2 is a block diagram illustrating three exemplary transactions constructed from header packets and data packets.

FIG. 3 is a block schematic diagram showing exemplary detail of the processor interface block of FIG. 1.

FIG. 4 is a block diagram showing exemplary detail of the header processor of FIG. 3.

FIG. 5 is a schematic illustration showing one transaction deletion from multiple fast data streams without corrupting or delaying other transactions from the fast data streams.

FIG. 6 is a flowchart illustrating one process for deleting transactions from multiple fast data streams.

### DETAILED DESCRIPTION OF THE FIGURES

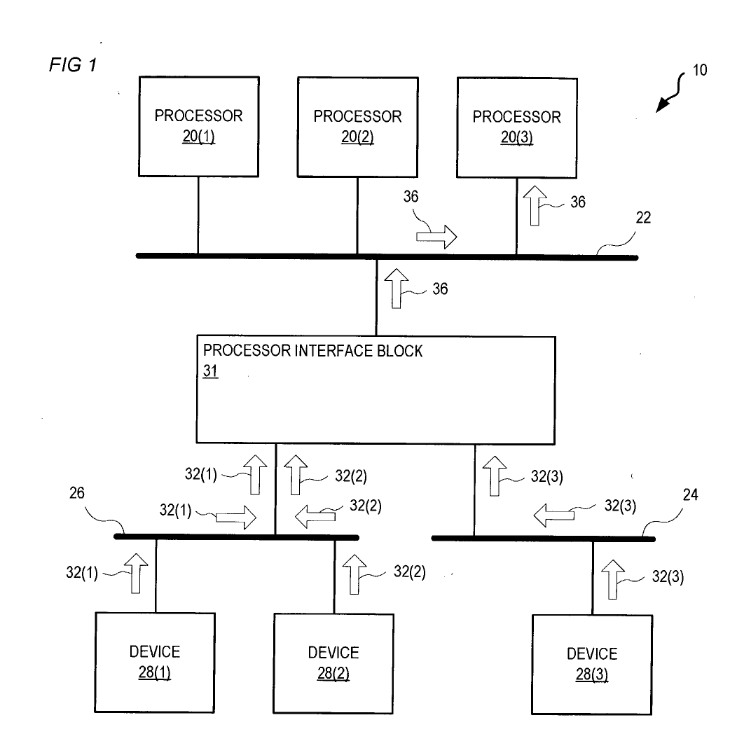

FIG. 1 is a block diagram showing one system 10 that combines three fast data streams, 32(1), 32(2) and 32(3), to form a single fast data stream 36. System 10 is illustratively shown with three processors 20(1), 20(2) and 20(3) connected to a processor bus 22, two high speed devices 28(1) and 28(2) connected to a first high speed bus 26, and a third high speed device 28(3) connected to a second high speed bus 24. Data streams 32 and 36 represent data communications from devices 28 to processors 20 over buses 24, 28 and 22. A processor interface block (“PIB”) 31 connects to processor bus 22, high speed buses 26 and 24, and operates to facilitate data communication between devices 28 and processors 20. PIB 31 may for example be a chipset, or the chipset may encompass PIB 31 and one or more devices 28.

In exemplary operation, high speed device 28(1) communicates data to PIB 31 in data stream 32(1) over fast bus 26. High speed device 28(2) communicates data to PIB 31 in data stream 32(2) over fast bus 26. High speed device 28(3) communicates data to PIB 31 in data stream 32(3) over high speed bus 24. PIB 31 communicates data from devices 28 to processor 20(3) in single fast data stream 36 over processor bus 22. High speed devices 28(1), 28(2) and 28(3) are, for example, random access memory, disk drives and graphical interfaces. One or more high speed devices 28 may also represent processor interface blocks within the chipset of PIB 31.

Additional data streams may exist within system 10, for example to facilitate data communication from processors 20 to devices 28 over busses 22, 24 and 26. FIG. 1 shows only four data streams 32(1), 32(2), 32(3) and 36 for clarity of illustration.

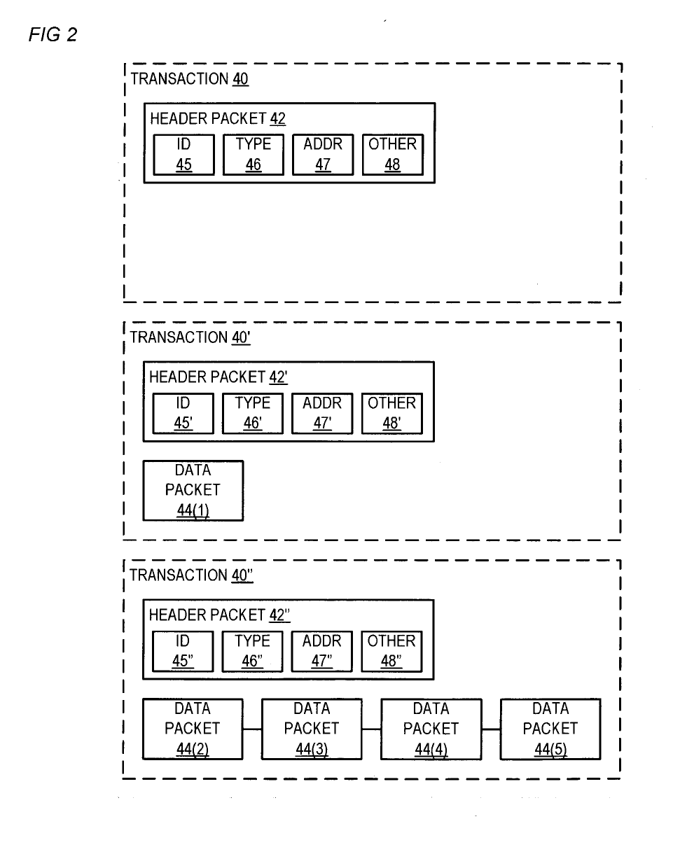

A transaction is a data structure that contains information transferred within data streams 32 and 36. Each transaction has a header packet and, optionally, one or more data packets, as illustrated in FIG. 2. In particular, FIG. 2 shows a block diagram of three exemplary transactions 40 used to transfer information within data streams 32(1), 32(2), 32(3) and 36. Transaction 40 has a header packet 42 and zero data packets. Transaction 40′ has a header packet 42′ and one data packet 44(1). Transaction 40″ has a header packet 42″ and four data packets 44(2), 44(3), 44(4) and 44(5). Header packets 42, 42′ and 42″ may each respectively contain a transaction ID 45, a transaction type 46, an address 47, and additional information 48, as illustrated. Transaction ID 45 is a unique identifier, used by system 10 to identify transaction 40. Transaction type 46 indicates the type of information and the number of data packets that are included in transaction 40. Address 47 defines a location in memory if transaction 40 is a data transfer. For example, if device 28(1) is a device containing random access memory, address 47 may define a location within the random access memory. Additional information 48 in header packet 42 may include, for example, error codes that operate to verify that information has been transferred without corruption.

Transactions 40, 40′ and 40″ are given as examples of transactions. Transactions may consist of other combinations of header and data packets without departing from the scope hereof.

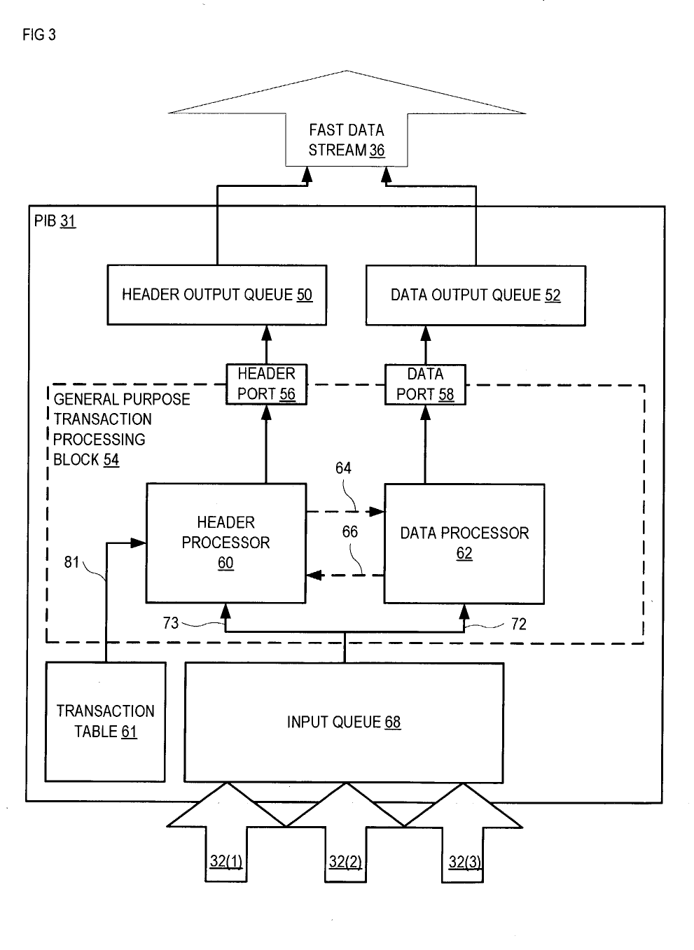

An exemplary embodiment of PIB 31, FIG. 1, is shown in FIG. 3, illustrating data communication from devices 28 to processors 20. As shown, PIB 31 combines fast data streams 32 into single fast data stream 36. PIB 31 is illustratively shown with a general purpose transaction processing block 54, which includes a header processor 60 and a data processor 62. Header processor 60 and data processor 62 operate according to control signals 64, 66 between one another to process header packet 42 and data packets 44, respectively. This controlled operation reduces latency and maximizes bandwidth associated with processing transactions 40 within PIB 31, thereby improving performance of system 10.

PIB 31 includes an input queue 68 that stores transactions 40 received from fast data streams 32(1), 32(2) and 32(3). Input queue 68 is, for example, a latch array within PIB 31. Input queue 68 is monitored by data processor 62, via a data path 72, to determine the packet type (header packet 42 or data packet 44) at the front of input queue 68. If, for example, header packet 42 is at the front of input queue 68, data processor 62 informs header processor 60, through control signal 66, to read header packet 42 from input queue 68; header processor 60 in turn reads the header packet of input queue 68 over data path 73. If, on the other hand, data packet 44 is at the front of input queue 68, data processor 62 reads data packet 44 from input queue 68 over data path 72.

Header processor 60 is operable to determine when a transaction is corrupted, erroneous or redundant. A “corrupted” transaction is for example a transaction that has an error identified by an error correction code (“ECC”). An “erroneous” transaction is for example a transaction that is unnecessarily or incorrectly generated within system 10. A “redundant” transaction is for example one transaction of a class of response transactions that may coalesce into a single transaction on output, e.g., to processor bus 22, FIG. 1, or into data stream 36. A cache coherency protocol violation by a processor 20 may also manifest as an erroneous transaction. Collectively, erroneous, redundant and corrupted transactions are herein identified as “unwanted” transactions.

In one embodiment, PIB 31 includes a transaction table 61 that stores active transactions originating from bus 22, FIG. 1. Header processor 60 may use information of transaction table 61 to identify unwanted transactions. By way of example, if a transaction 40 identifies itself as a “response” transaction, but there is no originating “request” transaction in transaction table 61, header processor 60 identifies this transaction 40 as unwanted.

In one embodiment, header processor 60 reformats header packet 42 to match the format of fast data stream 36, if necessary, and sends header packet 42 to a header output queue 50 via a header port 56. Header output queue 50 is, for example, a latch array within PIB 31. Header port 56 is an interface between general purpose transaction processing block 54 and header output queue 50; it may include ratio logic to facilitate transferring data from one clock frequency domain to another (e.g., from within block 54 to outside block 54). Header output queue 50 stores header packets 42 prior to output to single fast data stream 36 (i.e., over bus 22, FIG. 1).

In one embodiment, data processor 62 reformats data packets 44 to the format of fast data stream 36, if necessary, and sends data packets 44 to a data output queue 52 via a data port 58. Data output queue 52 is, for example, a latch array within PIB 31. Data port 58 is an interface between general purpose transaction processing block 54 and data output queue 52; it may include ratio logic to facilitate transferring data from one clock frequency domain to another (e.g., from within block 54 to outside block 54). Data output queue 52 stores data packets 44 prior to output to single fast data stream 36. Fast data stream 36 conveys the combined header and data packets to processor 20 over bus 22 of FIG. 1.

Communication within FIG. 3 may also occur in reverse order, from processors 20 to devices 28. Accordingly, PIB 31 may also include functionality that facilitates such reverse data communication; however such functionality is not shown for clarity. Moreover, those skilled in the art appreciate devices 28, FIG. 1, also typically include interface blocks to process transactions to and from PIB 31.

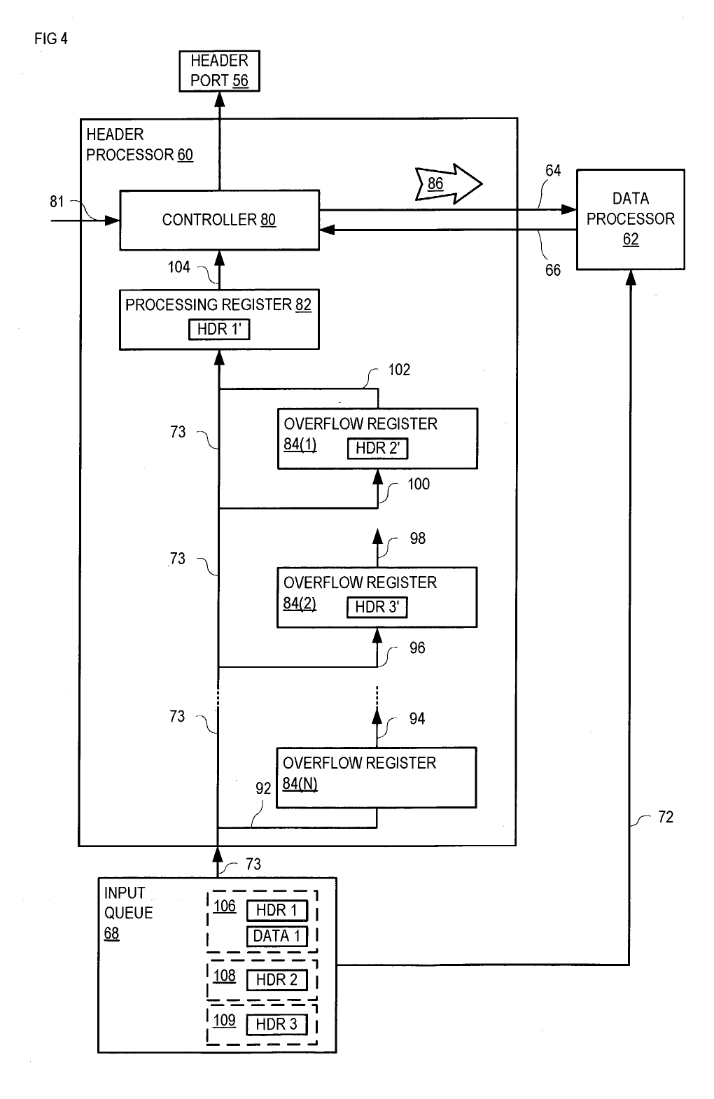

An exemplary embodiment of header processor 60, FIG. 3, is shown in FIG. 4, which further illustrates header packet processing and handling within header processor 60. Header processor 60 for example interacts with data processor 62, via control signals 64 and 66, to coordinate deleting transactions 40 from input queue 68, such that processing of transactions 40 from input queue 68 are not compromised, such that relative ordering and steady state performance of the transactions are maintained, and such that data packets of each transaction 40 are contiguous. In the illustrated embodiment of FIG. 4, header processor 60 includes a controller 80 and a processing register 82. Controller 80 coordinates header packet processing, header packet deletion, and data packet deletion within header processor 60. Processing register 82 stores a header packet 42 while being processed by controller 80.

Header processor 60 also includes a plurality of overflow registers 84, illustratively shown in FIG. 4 as overflow registers 84(1), 84(2) . . . 84(N) (N being an integer number of registers 84). Overflow registers 84 store header packets 42 received from input queue 68 while register 82 is in use. For example, a first transaction 106 contains a header packet HDR 1 and a data packet DATA 1. Transaction 106 is for example received from fast data stream 32(1) into input queue 68. Data processor 62 signals header processor 60, via control signal 66, to process header packet HDR 1. HDR 1 is loaded into header processing register 82 as HDR 1′ via data path 73, as shown.

In the example of FIG. 4, controller 80 connects to transaction table 61, FIG. 3, via data path 81 to determine whether transaction 106 is unwanted. If transaction 106 is unwanted, controller 80 sends a delete signal 86 to data processor 62. Delete signal 86 identifies fast data stream 32(1) as the source of transaction 106, such that data processor 62 in turn deletes associated data packets of transaction 106. If, in the meantime, a second transaction 108 is received by PIB 31, it is stored in input queue 68. During processing of HDR 1 by controller 80, for example, a header packet HDR 2 of transaction 108 is read from input queue 68 and stored in overflow register 84(1), via data paths 73 and 100. Similarly, if a third transaction 109 is received by PIB 31 during processing of HDR 1, its header packet HDR 3 is read from input queue 68 and stored in overflow register 84(2), via data paths 73 and 96.

Other header packets 42 received during processing of HDR 1 by controller 80 may be stored in overflow registers 84. More particularly, N header packets 42 may be stored within corresponding overflow registers 84, pending processing by controller 80. The N^{th} header packet 42 is for example stored in overflow register 84(N) via data path 92.

After completion of processing of HDR 1 by controller 80, HDR 2 is transferred from overflow register 84(1) to processing register 82 via data path 102. HDR 3 is also then transferred from overflow register 84(2) to overflow register 84(1) via data path 98, and so on, until the N^{th} transaction header packet is moved from overflow register 84(N) to overflow register 84(N−1) via data path 94.

In one embodiment, controller 80 informs data processor 62, via control signal 64, when header packets 42 are stored in overflow registers 84. Data processor 62 then waits before accepting data packets associated with header packets (stored in overflow registers 84) until header processor 60 determines whether the data packets 44 are to be deleted.

Header processor 60 thus processes header packets one by one. In processing each header packet, a determination is made whether the header packet is unwanted. This determination may include checking the ECC within the header packet; if the ECC indicates corruption, the entire transaction is deleted. Such an unwanted transaction may for example occur when a queue or bus of a chipset containing processor interface block 31 malfunctions.

The determination of an unwanted transaction may also include validating entries within transaction table 61. For example, a request transaction issued by a processor 20 on bus 22 (FIG. 1) is logged into transaction table 61. During processing of a response transaction to the request transaction, header processor 60 assesses table 61, via data path 81, to determine whether the response transaction matches the request transaction; if there is not a match, the transaction is deemed unwanted and deleted.

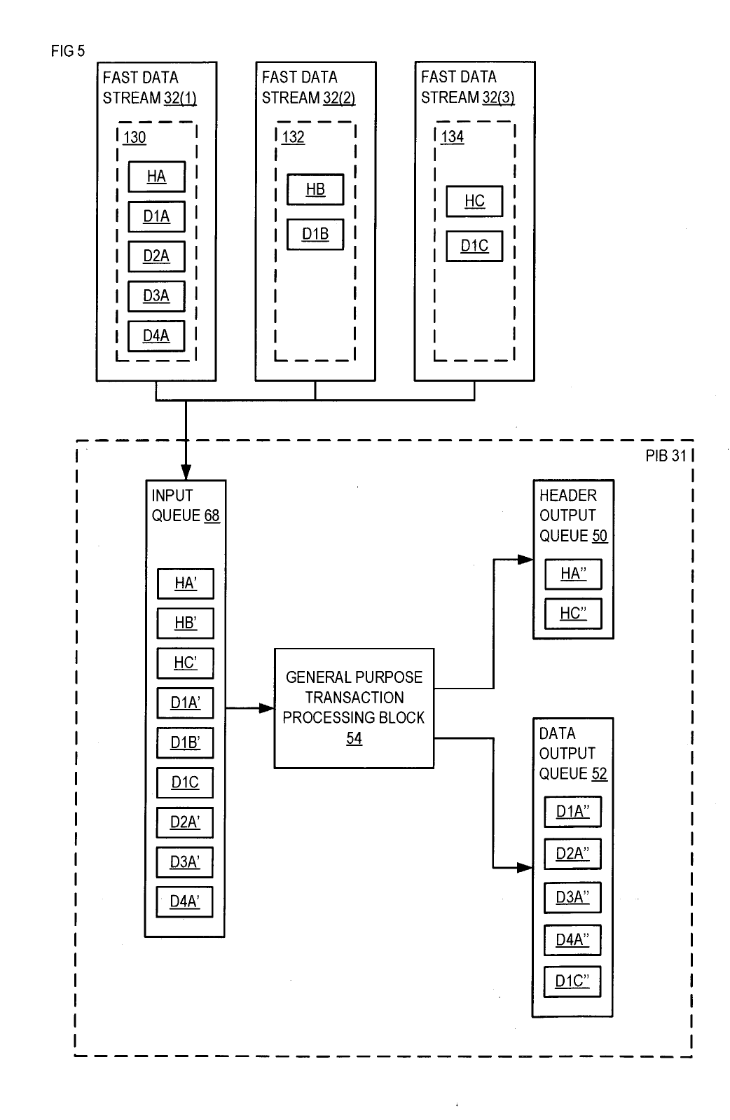

FIG. 5 is a block schematic diagram illustrating exemplary data processing by header processor 60 and data processor 62. In an illustrative example, fast data stream 32(1) has one transaction 130 constructed of one header packet HA and four data packets D1A, D2A, D3A and D4A. Fast data stream 32(2) has one transaction 132 constructed of one header packet HB and one data packet D1B. Fast data stream 32(3) has one transaction 134 constructed of one header packet HC and one data packet D1C. In the example, transactions 130, 132 and 134 arrive at input queue 68 concurrently; therefore individual packets of transactions 130, 132 and 134 become interleaved and stored as header packets HA′, HB′, HC′ and data packets D1A′, D1B′, D1C′, D2A′, D3A′ and D4A′ in input queue 68, as shown in FIG. 5.

In illustrative operation, data processor 62 instructs header processor 60 (via control signal 66) to process header packets HA′, HB′ and HC′ from input queue 68. Header processor sends processed header packet HA″ and HC″ to header output queue 50, as shown. In this example, upon processing header packet HB′, header processor 60 determines that transaction 132 of fast data stream 32(2) is unwanted. Header processor 60 deletes header packet HB′ and instructs data processor, via control signal 64, to delete data packet D1B from fast data stream 32(2). Concurrently, data processor 62 processes data packets D1A′, D1B′, D2A′, D3A′, D4A′ and D1C′ from input queue 68 and sends processed data packets D1A″, D2A″, D3A″, D4A″ and D1C″ to data output queue 52; data packet D1B′ is not sent to output queue 52 because, in this example, it is unwanted.

More particularly, the processing time for individual header and data packets may differ; and the order in which header packets HA″ and HC″ are sent to single fast output data stream 36, relative to data packets D1A″, D2A″, D3A41 , D4A″ and D1C″, may be indeterminate. However, if header packet HA′ is received by PIB 31 before header packet HC′, header packet HA″ is sent to header output queue 50 prior to header packet HC″. Likewise, data packets D1A″, D2A″, D3A″, D4A″ and D1C″ are sent to data output queue 52 in the order in which they are received. PIB 31 thus operates such that data packets 44 of a transaction 40 are not processed before header packets 42 of the same transaction 40.

In the example, when header processor 60 completes processing of header packet HA′, data processor 62 instructs header processor 60 to read header packet HB′ from input queue 68. Header processor 60 analyzes header packet HB′ and determines that transaction 132 of fast data stream 32(2) is unwanted and is to be deleted; header processor 60 sends delete signal 86 to data processor 62, via control signal 64. Delete signal 86 identifies fast data stream 32(2) as containing to-be-deleted transaction 132; upon receipt of delete signal 86, data processor 62 deletes the appropriate number of data packets. In this example, transaction 132 has only one data packet D1B, and data processor 62 therefore deletes one data packet D1B′ received from data stream 32(2).

Accordingly, in the example, data processor 62 detects header packet HC′ at the top of input queue 68 and instructs header processor 60 to read HC′. Controller 80 of header processor 60 is currently processing HB′ in processing register 82; HC′ loads into overflow register 84(1), via data path 100, until register 82 clears. Data processor 62 reads and processes data packet D1A′ from input queue 68, outputting it as D1A″ to data output queue 52. Data processor 62 then reads D1B′ from input queue 68, identifies it as being received from fast data stream 32(2), and deletes it as instructed by delete signal 86. Data processor 62 waits to read D1C′ from input queue 68 since HC′ of transaction 134 is held in overflow buffer 84(1) of header processor 60 and is not yet processed by controller 80.

Header processor 60 then deletes header packet HB′ from processing register 82 and moves header packet HC′ from overflow register 84(1) to processing register 82. If further header packets are contained within overflow buffer 84, overflow buffer 84 is updated by transferring header packet 42 of overflow register 84(2) to overflow register 84(1), transferring header packet 42 of overflow buffer 84(3) to overflow buffer 84(2), and so on, until all header packets 42 are cascaded upwards within overflow registers 84. Header processor 60 updates data processor 62, via control signal 64, identifying header packets 42 stored in overflow registers 84. Header processor 60 then continues processing of HC′ in processing register 82. Accordingly, data processor 62 continues processing data packet D1C and then data packets D2A′, D3A′, and D4A′ from input queue 68.

In one embodiment, transactions 130 and 134 from fast data streams 32(1) and 32(3) are processed by header processor 60 and data processor 62, respectively, such that ordering of header packets HA′ and HC′ and data packets D1A′, D2A′, D3A′, D4A′ and D1C′ conform to a round robin arbitration scheme utilized within system 10, FIG. 1.

In one embodiment, a transaction consisting of only a header packet is deleted. Such a transaction may be deleted without interaction between header processor 60 and data processor 62.

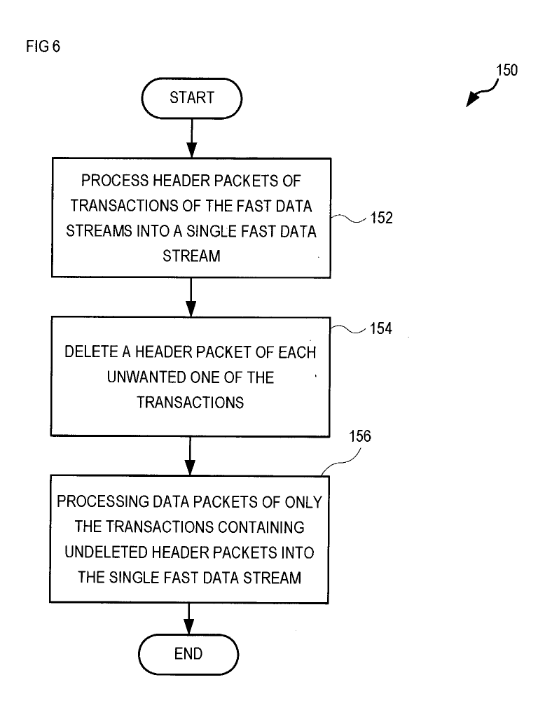

FIG. 6 is a flowchart illustrating one process 150 for deleting transactions 40 from multiple fast data streams 32. In step 152, header packets of transactions of the fast data streams are processed (e.g., by header processor 60, FIG. 3) into a single fast data stream. In step 154, a header packet of each unwanted one of the transactions is deleted (e.g., by the header processor 60, FIG. 3). In step 156, data packets of only the transactions containing undeleted header packets are processed (e.g., by data processor 62, FIG. 3) into the single fast data stream, in step 156.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for deleting transactions from multiple fast data streams, comprising:
processing header packets of transactions of the fast data streams into a single fast data stream;
deleting a header packet of each unwanted one of the transactions; and
processing data packets of only the transactions containing undeleted header packets into the single fast data stream.

2. The method of claim 1, further comprising the step of determining when the one transaction is unwanted.

3. The method of claim 2, the step of determining comprising determining if the one transaction is corrupted.

4. The method of claim 3, the step of determining if the one transaction is corrupted comprising checking an error correction code of the header packet.

5. The method of claim 2, the step of determining comprising determining if the one transaction is redundant.

6. The method of claim 2, the step of determining comprising determining if a transaction is erroneous.

7. The method of claim 1, if the one transaction has one or more data packets, further comprising deleting the data packets.

8. A system for deleting transactions from multiple fast data streams, comprising:
a header processor for processing header packets of transactions of the multiple fast data streams into a single fast data stream, the header processor operable to determine and delete a header packet of each unwanted transaction; and
a data processor responsive to the header processor for processing data packets of only the transactions containing undeleted header packets into the single fast data stream.

9. The system of claim 8, wherein the header processor communicates a signal to the data processor upon determining an unwanted transaction.

10. The system of claim 9, the signal comprising identification of the one unwanted transaction.

11. The system of claim 10, the signal comprising identification of a number of data packets of the one unwanted transaction.

12. The system of claim 8, the header processor being operable to determine whether the transaction is unwanted by determining if the one transaction is corrupted.

13. The system of claim 12, the header processor being operable to check an error correction code of the header packet.

14. The system of claim 8, the header processor being operable to determine whether the transaction is unwanted by determining if the one transaction is erroneous.

15. The system of claim 14, further comprising a transaction table, the header processor being operable to determine whether the transaction is erroneous by accessing the transaction table.

16. A system for deleting transactions from multiple fast data streams, comprising:
means for processing header packets of transactions of the fast data streams into a single fast data stream;
means for deleting a header packet of each unwanted one of the transactions; and
means for processing data packets of only the transactions containing undeleted header packets into the single fast data stream.

17. The system of claim 16, further comprising means for determining when the one transaction is unwanted.

18. The system of claim 17, further comprising a transaction table for storing transaction identifiers associated with the transactions, the means for determining comprising means for determining if a transaction is duplicated within a transaction table.
